(19) United States
(12) Patent Application Publication
(10) Pub. No.: US 2016/0110834 A1
(43) Pub. Date: Apr. 21, 2016

(54) Emergency Response Management System and Method

(71) Applicant: Enviro-Response, LLC, Dallas, TX (US)

(72) Inventors: Paul W. Nelson, Palm Harbor, FL (US); J. Michael Powell, Tampa, FL (US); Lawrence L. Rosenbloom, Dallas, TX (US)

(73) Assignee: Enviro-Response, LLC, Dallas, TX (US)

(21) Appl. No.: 14/518,736

(22) Filed: Oct. 20, 2014

(51) Int. Cl. G06Q 50/26; G06Q 10/06

(52) U.S. Cl. CPC G06Q 50/265; G06Q 10/06311

(57) ABSTRACT

An automated disaster management system and method for power generators is disclosed. The system/method includes emergency computing devices (ECDs) communicating with an emergency web server (EWS) over a network. The EWS interacts with an emergency database (EDB), emergency task scheduler (ETS), emergency resource analyzer (ERA), emergency work order generator (EWG), and emergency management application (EMA). A service agency receives a request for installation/service/de-installation from a customer agency through the EMA. The EWG generates and transmits a work order to a crew that receives the work order and performs the operation at the job site after locating it with the ERA. Before, during, and after completion of an operation, the crew member via the EMA/EWS, dynamically updates reports to government and local stakeholders. Another embodiment includes a system to detect generator malfunctioning in real time and react accordingly to provide uninterrupted service during an emergency situation.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally relates to emergency response management for power generators. The invention employs a mechanism to generate, schedule and implement power generator service in an emergency situation. The invention also dynamically detects and alerts changes in equipment functioning and providing real time updates to stakeholders.

### PRIOR ART AND BACKGROUND OF THE INVENTION

### Prior Art Background

Federal agencies such as USACE have the capabilities to provide local and state officials broad support for their unmet temporary emergency power needs. This support ranges from technical expertise/assistance through complete management of an emergency power mission including the procurement, installation and operation of generators. USACE assets include elements of the U.S. Army 249th Engineer Battalion “Prime Power”, Emergency Power Planning & Response Teams (PRTs) from across USACE, USACE-contracted forces, and USACE Deployable Tactical Operations System (DTOS) for communications. USACE also coordinates with other federal partners such as the Federal Emergency Management Agency (FEMA) and the Department of Energy (DOE). These assets can provide Technical Assistance before, during or after an event which includes, but is not limited to:
Assessing emergency power requirements needed at a facility
Assessing conditions & capabilities of existing emergency generation equipment
Troubleshooting, repair, and operation of emergency generation/distribution equipment
Installation, operations, fueling and maintaining emergency power generation equipment
Safety inspections of electrical distribution systems and equipment
Assessing damaged electrical distribution systems and equipment
All hazards emergency power planning

The execution of a power mission in an emergency involves the combined efforts of the 249th, the Power PRT, DTOS, the ACI contractor, and state and federal partners. During these missions, the Technical Assistance items discussed above are brought to bear along with the following:
Provide assistance to state and local officials in determining priorities for assessing and installing generators at critical public facilities.
Assessing facilities to determine suitability for a generator, location for its placement and matching with the correct generator configuration.
Preparation, hauling, and installation of generators.
Operation, fueling, service, and maintenance of installed generators.
De-installation and return of generators. This can also include remediation of the generator installation site to its pre-installation site condition.
Service, maintenance, and repair of generators prior to their return to long-term storage to ensure they are Fully Mission Capable (FMC). This may also include load testing.
Replenishing any Bill of Materials (BOM) used during execution of the mission Operational maintenance of FEMA generators is performed by a combination of 249th, PRT, and contractual support.

Generator procurement and/or leasing can be performed by USACE through a contracting team which has pre-established contracting tools.

Purchase of generators during disaster response is not recommended. The USACE pre-established contracts allow leasing and rental of generators if the FEMA inventory cannot satisfy needs. Historically, most generators purchased during disaster responses required extensive modifications to meet FEMA acceptance criteria to be included into their inventory.

During Emergency Power response activities, facilities requiring generators are typically prioritized in the following order:

1. Life Saving Facilities (911 centers, police, fire stations, and medical facilities)

2. Life Sustaining Facilities (water and wastewater treatment and pumping facilities)

3. Other municipal facilities to reinstitute local command and control and post-event recovery.

Currently, there are no efficiently coordinated systems to deliver, and/or install, and/or remove/un-install equipment or supplies in an emergency or disaster situation. Current systems lack the ability to operate in an environment where local power and standard network communication may not be available.

Restoring power is a priority for federal officials, because so much of the cleanup depends on electricity. FEMA's large, truck-delivered generators are different from ones that would supply a single-family home with electricity. Instead, they are meant to serve critical locations such as hospitals, nursing homes, and government offices. Not all types of equipment can be used for every task. In cases such as storm recovery, FEMA provides states with information about the various generators they can tap. In turn, states must identify their needs and assign particular equipment from the FEMA allotment. Such assessments by state officials can take time as needs shift during the first few hours and days following a disaster. Once states identify which equipment is needed, the Army Corps of Engineers manages the equipment.

Prior art does not provide for a system that provides information needed to find the task area, locate the required equipment, the required facility and then ensures that the all required steps are completed and all required approvals are obtained. A generator comes with a driver, or the driver must be supplied, and then cabling, electrician, etc. needs to be identified for installed and coordinated.

Majority of tasks in an Emergency Operations Center is about moving people and equipment which come with logistical challenges such as a Generator, the right cabling, the right adapters, and how it is being shipped to where it needs to be. If the Generator is a large one, then it also requires a licensed installer, a fork lift to move it, a fork lift operator, a truck, and a truck driver.

Current systems do not efficiently automate the paper workflow associated with the key steps in an emergency/disaster. Stakeholders in an emergency include State Governor, county officials, city mayor, government department heads, FEMA representatives and others. These stakeholders demand up-to-date accurate information about what is planned, what has been completed and what is in-progress. Present emergency management systems and methods do not provide real time accurate information to key stakeholders during an emergency situation.

There are capabilities to meet the needs of the community in the amount of equipment that is out there. However, implementing standards of business processes to manage that equipment and enable an incident commander to complete the majority of the task is lacking in the current system. A properly developed and managed logistics “system of record” is needed to solve the problem. Pre-planning, coordinating, and managing suppliers of all types (private contractors, mutual aid partners, NGOs, FEMA) in a timely fashion and in a way that insures that all the critical logistical details are met is lacking in the current method of managing power during a disaster.

### Deficiencies in the Prior Art

The prior art as detailed above suffers from the following deficiencies:
Prior art methods generally do not provide an efficient coordinated system to deliver, and/or install and/or remove/un-install equipment or supplies in an emergency or disaster situation.
Prior art methods generally do not provide a system that operates in an environment where local power and standard network communication may not be available.
Prior art generally do not provide systems to automate the paper workflow associated with the key steps in an emergency/disaster.
Prior art systems do not generally provide an automatic work order change management system.
Prior art systems do not generally provide for an automatic equipment malfunction/service detection and alert system.
Prior art systems do not generally provide for real time status updates to key stake holders and administrators.

While some of the prior art may teach some solutions to several of these problems, the core issue of dynamically detecting changes, coordinating, real-time updates, and improving overall efficiency has not been addressed by prior art.

### OBJECTIVES OF THE INVENTION

Accordingly, the objectives of the present invention are (among others) to circumvent the deficiencies in the prior art and affect the following objectives:
Provide an efficient coordinated emergency response system to deliver, and/or install, and/or remove/un-install equipment or supplies in an emergency or disaster situation.
Provide for an emergency response system that operates in an environment where local power and network communication may not be available.
Provide for an emergency response system to automate the paper workflow associated with the key steps in an emergency/disaster.
Provide for an emergency response system that automatically manages work order changes.
Provide for an emergency response system for automatic equipment malfunction/service detection and alerts.
Provide for an emergency response system for real time status updates to key stake holders and administrators.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

### System Overview

The present invention in various embodiments addresses one or more of the above objectives in the following manner. The present invention dynamically detects changes in power generators and reacts accordingly during an emergency situation. The system/method includes emergency computing devices (ECDs) communicating with an emergency web server (EWS) over a network. The EWS interacts with an emergency database (EDB), emergency task scheduler (ETS), emergency resource analyzer (ERA), emergency work order generator (EWG), and emergency management application (EMA). A service agency receives a request for installation/service/de-installation from a customer agency through the EMA. The EWG generates and transmits a work order to a crew that receives the work order and performs the operation at the job site after locating it with the ERA. Before, during, and after completion of an operation, the crew member via the EMA/EWS, dynamically updates reports to government and local stakeholders. Another embodiment includes a system to detect generator malfunctioning in real time and react accordingly to provide uninterrupted service during an emergency situation.

### Method Overview

The present invention system may be utilized in the context of an overall emergency management method, wherein the emergency management system described previously is controlled by a method having the following steps:
(1) with the ECD, receiving a request from a customer agency for installing a power generator;
(2) with the EWG, generating a work order from the received request;
(3) setting up an incident support base (ISB) with staging crew and the MCDs;
(4) with the ERA, locating the power generator with the EDB and notifying crew members with the ETS;
(5) transporting the power generator to a job location;
(6) installing the power generator at the job location and updating completion status with the MCD;
(7) servicing the power generator on a scheduled basis and updating maintenance status with the MCD;
(8) with the ECD, receiving a request from a customer agency for uninstalling the power generator; and
(9) uninstalling the power generator and notifying stakeholders with the MCD.
Integration of this and other preferred exemplary embodiment methods in conjunction with a variety of preferred exemplary embodiment systems described herein in anticipation by the overall scope of the present invention.

### BRIEF DESCRIPTION OF THE DRAWINGS

For a fuller understanding of the advantages provided by the invention, reference should be made to the following detailed description together with the accompanying drawings wherein:

FIG. 1 illustrates an exemplary emergency system overview diagram describing a presently preferred embodiment of the present invention.

FIG. 2 illustrates an exemplary emergency system incident support base (ISB) overview diagram describing a presently preferred embodiment of the present invention.

FIG. 3 illustrates an emergency response power management method exemplary overview flowchart describing a presently preferred exemplary embodiment of the present invention.

FIG. 4 illustrates an exemplary block diagram of a preferred emergency database (EDB) embodiment.

FIG. 5 illustrates an exemplary block diagram of a preferred exemplary operations database (ODB) embodiment.

FIG. 6 illustrates an exemplary block diagram of a preferred exemplary resources database (RDB) embodiment.

FIG. 7 illustrates an exemplary block diagram of a preferred exemplary transport database (TDB) embodiment.

FIG. 8 illustrates an exemplary block diagram of a preferred exemplary crew database (CDB) embodiment.

FIG. 9 illustrates an exemplary graphical user interface for an emergency system according to an embodiment of the present invention.

FIG. 10 illustrates an exemplary graphical user interface for emergency forms according to an embodiment of the present invention.

FIG. 11 illustrates a detailed flowchart of a preferred exemplary work order creation and processing method in some preferred exemplary invention embodiments.

FIG. 12 illustrates a written work order request from a customer agency.

FIG. 13 illustrates a detailed installation work order form according to an embodiment of the present invention.

FIG. 14 illustrates a detailed installation work order form according to an embodiment of the present invention.

FIG. 15 illustrates a detailed flowchart of a preferred exemplary equipment preparation and deployment method in some preferred exemplary invention embodiments.

FIG. 16 illustrates an exemplary checklist of a preferred generator preparation.

FIG. 18 illustrates a detailed flowchart of a preferred exemplary equipment installation method in some preferred exemplary invention embodiments.

FIG. 19 illustrates a preferred exemplary report of a site condition report.

FIG. 21 illustrates a detailed flowchart of a preferred exemplary equipment service/re-fuel method in some preferred exemplary invention embodiments.

FIG. 22 illustrates a preferred exemplary fuel ticket for a service request.

FIG. 23 illustrates a detailed flowchart of a preferred exemplary equipment de-installation method in some preferred exemplary invention embodiments.

FIG. 25 illustrates a detailed de-installation work order form according to an embodiment of the present invention.

FIG. 26 illustrates a detailed de-installation work order form according to an embodiment of the present invention.

FIG. 27 illustrates a detailed emergency browser interface according to an embodiment of the present invention.

FIG. 28 illustrates a detailed flowchart of a preferred exemplary automatic work order change management method in some preferred exemplary invention embodiments.

FIG. 29 illustrates a detailed flowchart of a preferred exemplary automatic change detection method in some preferred exemplary invention embodiments.

FIG. 30 illustrates an exemplary preferred emergency power generator coupled to a transponder.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of an emergency management system and method. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Preferred Embodiment System Block Diagram (0100)

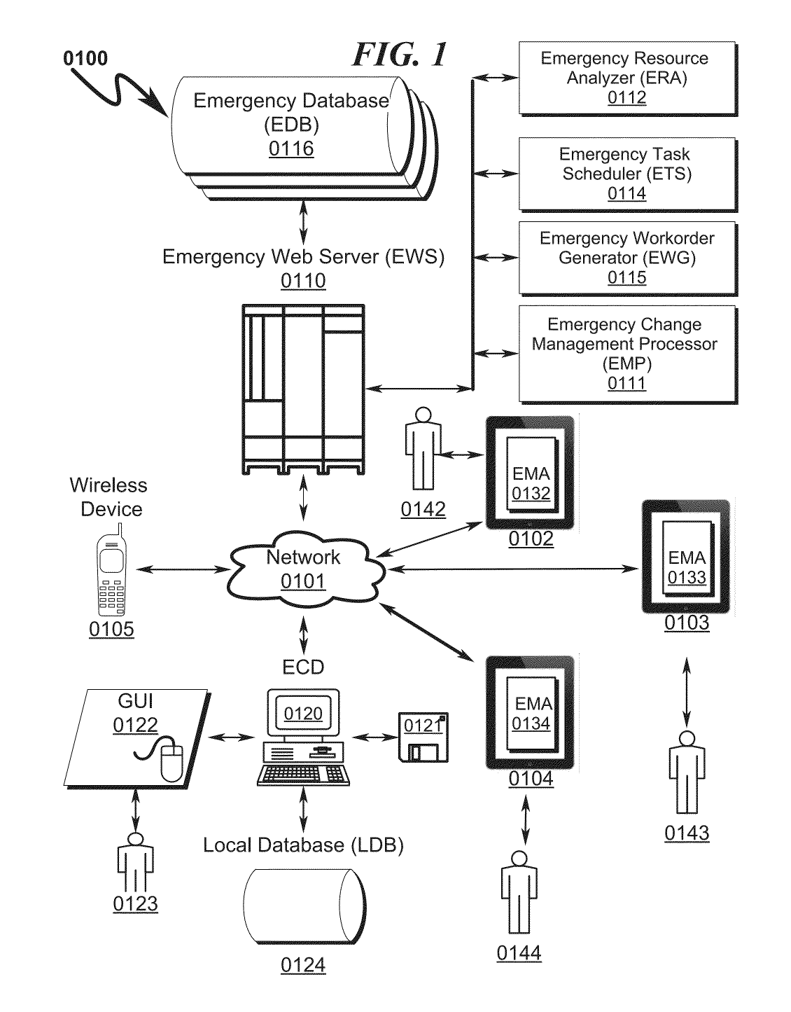

The present invention may be seen in more detail as generally illustrated in FIG. 1 (0100), wherein an emergency web server (EWS) (0110) is coupled to plurality of emergency computing devices (ECDs) (0120) through a network (0101). The EWS (0110) is coupled to a plurality of EDBs (0116), an emergency resources analyzer (ERA) (0112), an emergency task scheduler (ETS) (0114), an emergency work order generator (EWG) (0115), and an emergency change management processor (EMP) (0111). The EWS (0110) is configured to connect to a network for providing connectivity to the ECDs (0120) and plural mobile computing devices (MCDs) (0102, 0103, 0104). The network may include a wired protocol such as Ethernet or wireless protocol such as 3G, 4G, WIFI, NFC, WLAN, and LTE.

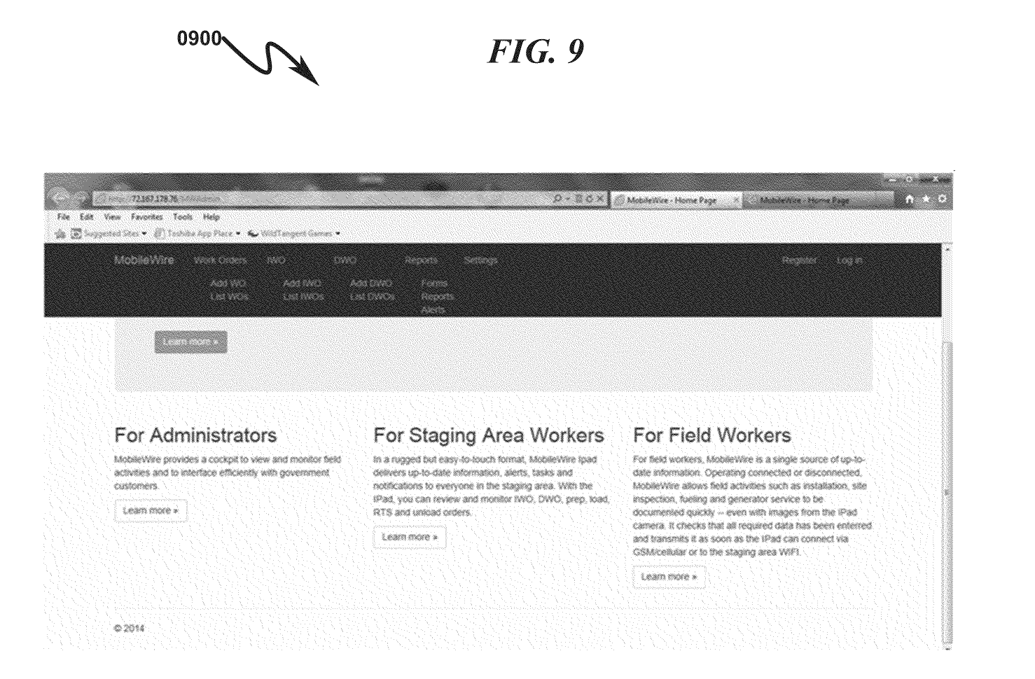

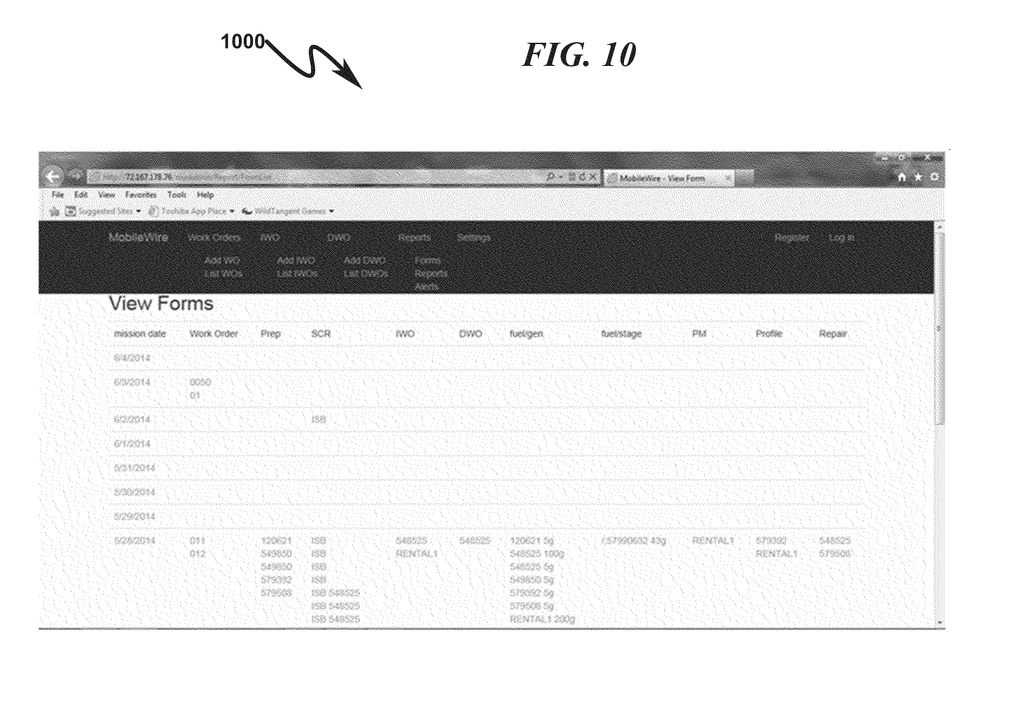

The ECDs (0120) are configured for enabling users such as project managers, team leaders, administrators, stakeholders, and suppliers to interact with EWS (0110) and EDBs (0116). The ECDs (0120) may further comprise a microprocessor executing instructions read from a computer-readable medium (0121) and a graphical user interface (GUI) (0122) with a pointing device. The users may open GUI (0122) and select EDBs (0116) for updating records. The administrators may receive requests through the ECD (0120) or manually. Subsequently, they may process and pass the information to the EWG (0115) through the EWS (0110) for further processing. A more detailed view of GUI (0122) may be seen in FIG. 9 (0900) and FIG. 10 (1000).

The EDBs (0116) are configured for enabling the users to update or extract records from the EDBs after establishing a connection with EWS (0110) through the network (0101). The EDBs (0116) may be executed through any of widely available database implementations such RDMS, SQL etc. The databases (0116) may be stored in network storage servers such as Fibre Channel, PCIe, SAS, and SATA.

The ETS (0114) is configured for sequencing emergency operations to establish a flow for the operations. For example, an install operation may comprise an install work order (IWO) generated by EWG, the IWO transmitted to a yard supervisor, then to a driver, then an electrician, and then reviewed by an electrical manager. The ETS (0114) also dispatches work orders after sequencing the operations. Field crew members (0144) and staging crew members (0143) receive notification alerts on their mobile computing devices (0102, 0103, 0104) through the EWS (0110).

The ERA (0112) is configured to analyze resources for the operations and notify the resources of the operation requirements. The ERA (0112) also prioritizes tasks based on a pre-determined criteria set by the customer agency. For example, priorities may be set in the following order

1. Life Saving Facilities (911 centers, police, fire stations, and medical facilities)

2. Life Sustaining Facilities (water and wastewater treatment and pumping facilities)

3. Other municipal facilities to reinstitute local command and control and post-event recovery.

The ERA (0112) may further analyze resources such as drivers, certifications, and equipment and match them accordingly to the operation requirements. The ERA (0112) passes information to the ETS (0114) to message the concerned crew member or staging member equipped with a mobile computing device (MCD) or a wireless device (0105).

The EMAs (0132, 0133, 0134) are installed on MCDs (0102, 0103, 0104) respectively. The EMAs (0132) are launched on the MCDs to provide crew members an interface to retrieve, enter and update information to the EWS (0110).

The EWG (0115) is configured to generate a work order based on the request received. The work orders could be intended for equipment installation, de-installation, servicing, fueling and and/or checking. The EWG (0115) is further configured to pass the information to the ERA (0112) for resource analysis and to the ETS (0114) for scheduling and notifying.

The EMP (0111) is configured to probe EDBs (0116) for detecting changes to work orders. Customer agencies may request changes to equipment size, equipment model, job site location, or number of equipment. The EWG (0115) is further configured to dynamically generate and update the work orders based on the changes detected by EMP (0115). The EMP (0115) also detects changes in equipment functioning through reception of signals from equipment's (generators) transponders. An electronic control panel on the generator may monitor the functioning of the generator and communicate functioning status through the transponder. The generators in the field may be equipped with the specialty transponders that emit signals when the generator is running higher than the rated load capacity, generator fails, fuel empty condition and/or other failure conditions. According to a preferred exemplary embodiment, providing real time power generator operation information during an emergency and adjust/react in real time to generator failure or ineffective conditions.

### Preferred Embodiment System Block Diagram (0200)

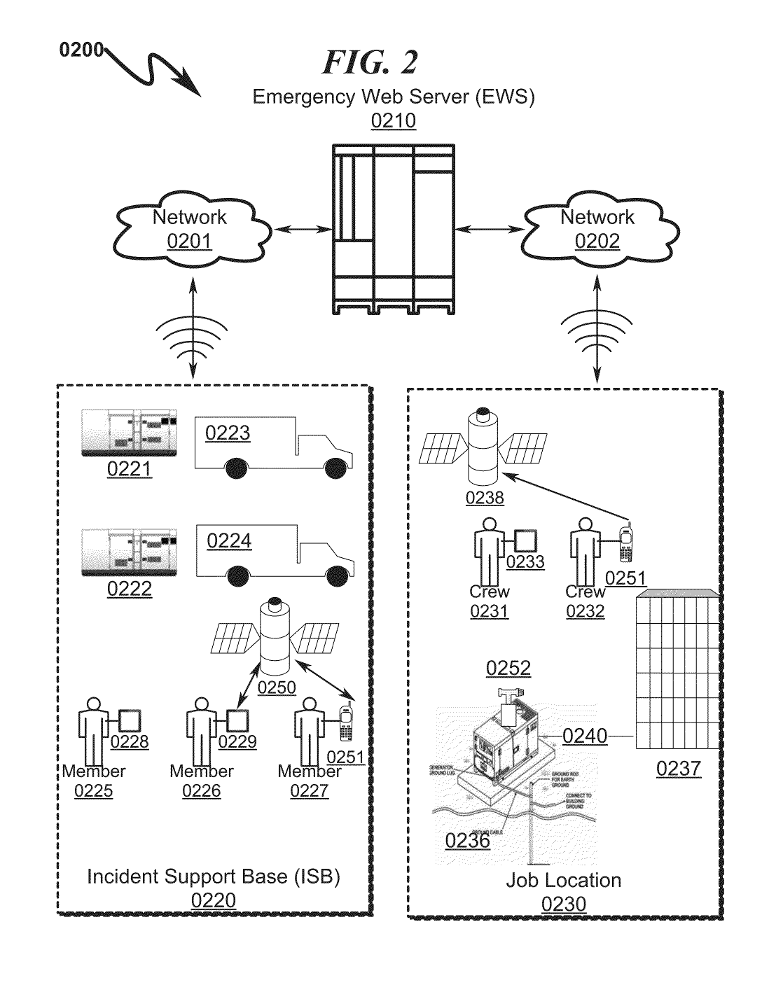

The present invention may be seen in more detail as generally illustrated in FIG. 2 (0200), wherein a service agency sets up a support base (ISB) (0220) to service a job location (0230). The ISB (0220) may include a plurality of service agency certified power generators (0221, 0222), equipment trucks (0223, 0224), staging crew (0225, 0226, 0227) carrying mobile computing devices (MCDs) (0228, 0229) or wireless devices (0251). The ISB (0220) may have an incident commander to manage the activities of the response operation. The ISB (0220) may communicate to an emergency web server (0210) through a network (0201). The network could be wired such as Ethernet or wireless such as 3G, 4G, WIFI depending on the physical location of the ISB (0220). A satellite communication instrument (0250) may also be used to communicate with EWS (0210).

Upon receiving a notification on a mobile computing device (0233), a licensed driver (0231) along with an electrician (0232) may transport a power generator (0236) in an equipment truck (0223). The electrician (0232) surveys the job location (0230) and uploads the site specific information via network (0202) to the emergency web server (0210). The electrician may also upload a cabling and connection plan to the EWS (0210). Subsequently, the electrician (0210) may run the cables (0240) and connect the power generator (0221) to a facility (0237). An authorization from the ISB (0220) and incident commander may or may not be required to complete the generator hook up. In certain instances a satellite communication instrument (0238) may communicate directly with the EWS (0210).

If a communication network (0202) is not available at the job location, the electrician (0232) may still use the MCD (0233) or a wireless device (0251) to document the site findings, cabling route, connection plan, transponder condition, and generator operating information. The field crew member may subsequently upload the documented information upon reaching the ISB (0220) or when a network connection is available. According to a preferred exemplary embodiment, the field crew could continue to document and execute the work order without network availability. In this case, the system provides a dedicated WIFI network at the ISB (0220) where the MCDs can communicate, receive updates, and upload forms that the user has completed.

When operating without network service, the field crew member (0232) is able to create an installation work order for example, select a generator and complete the installation form. This includes taking pictures of the site as required. This form, along with any others created by the user, is stored on the MCD (0233) and transmitted to the EWS (0210) as soon as a WIFI connection or a wireless connection is available. This redundancy allows the technicians (field crew) to continue working even when cell towers (network) are down, but to download this data as soon as possible.

### Preferred Exemplary Method Embodiment (0300)

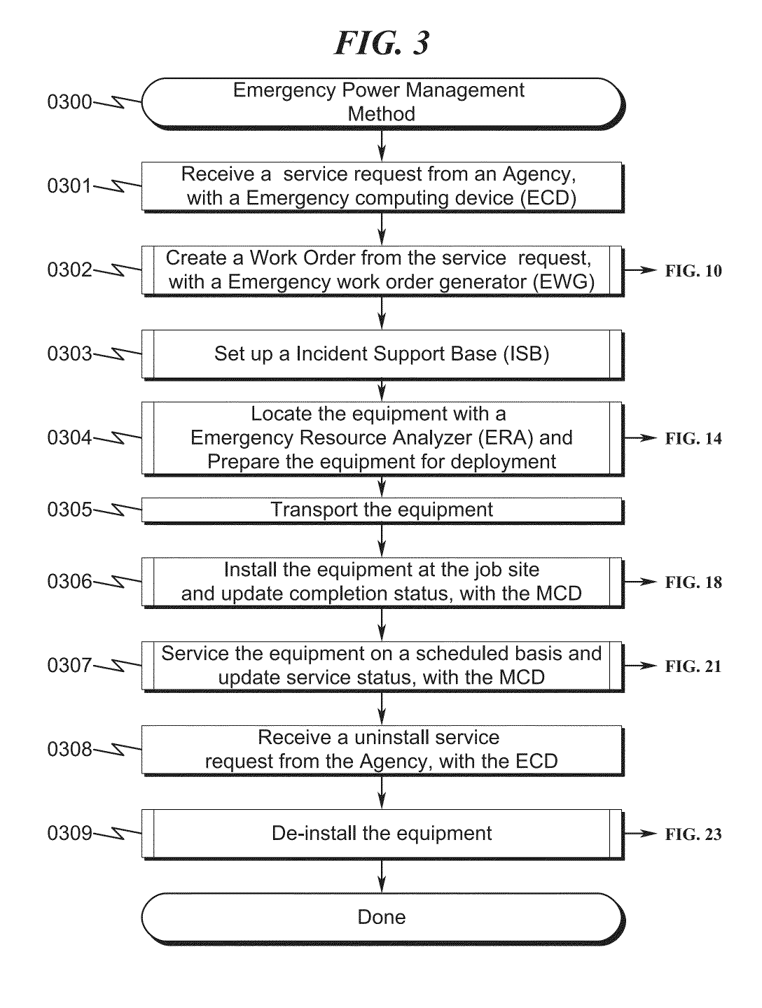

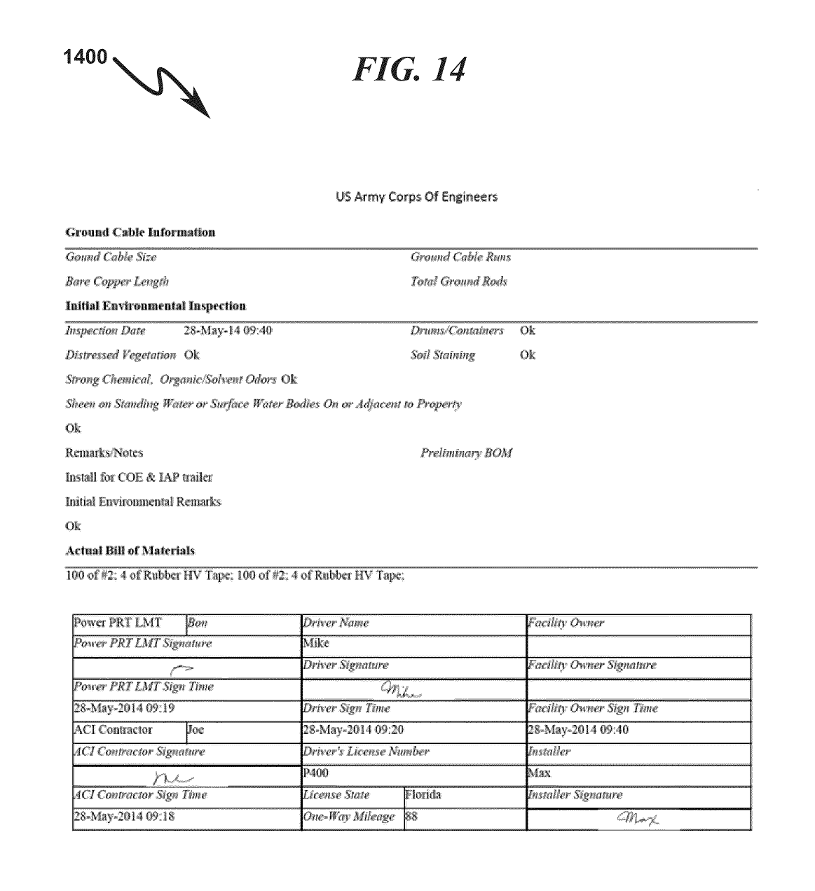

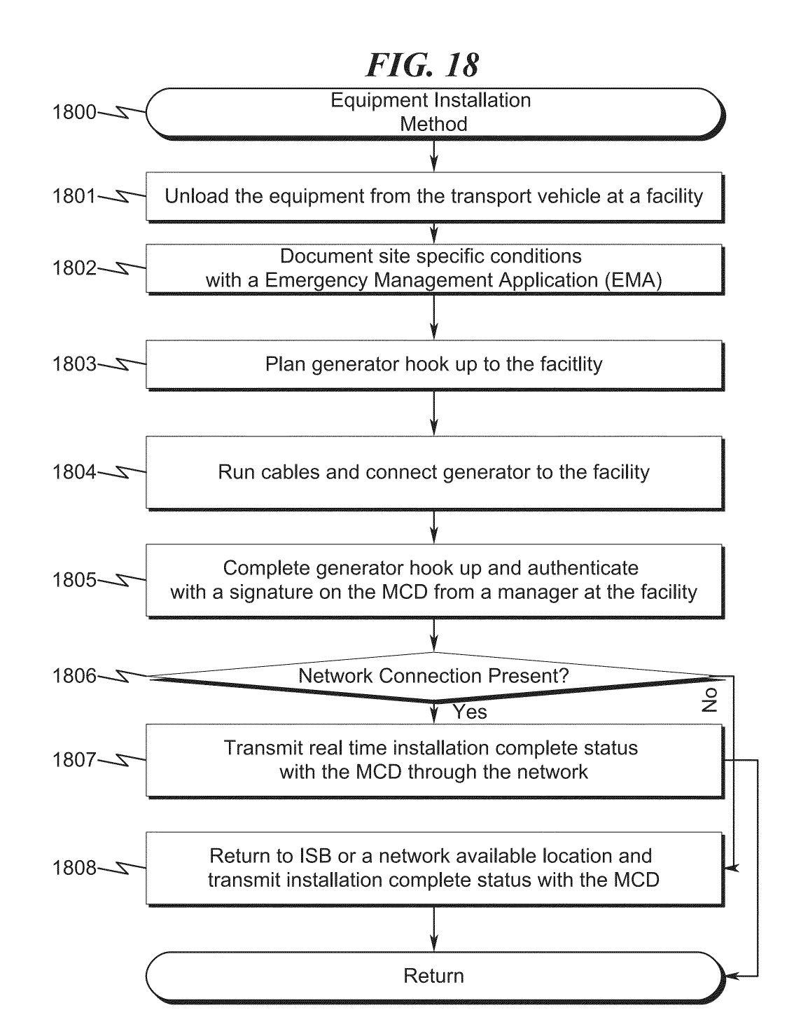

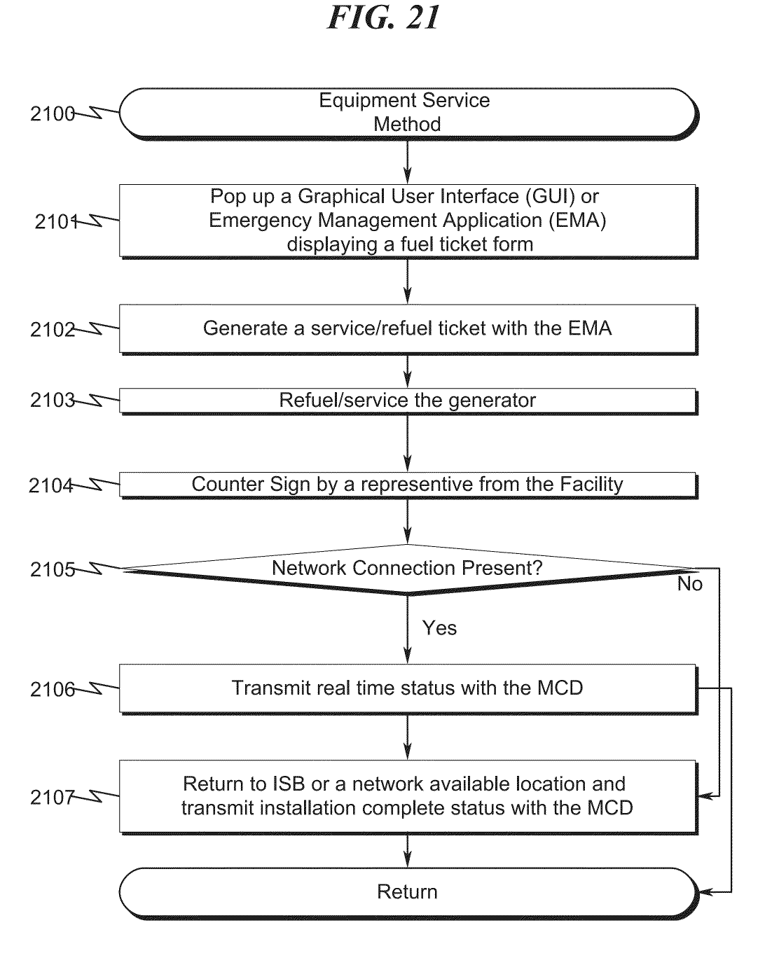

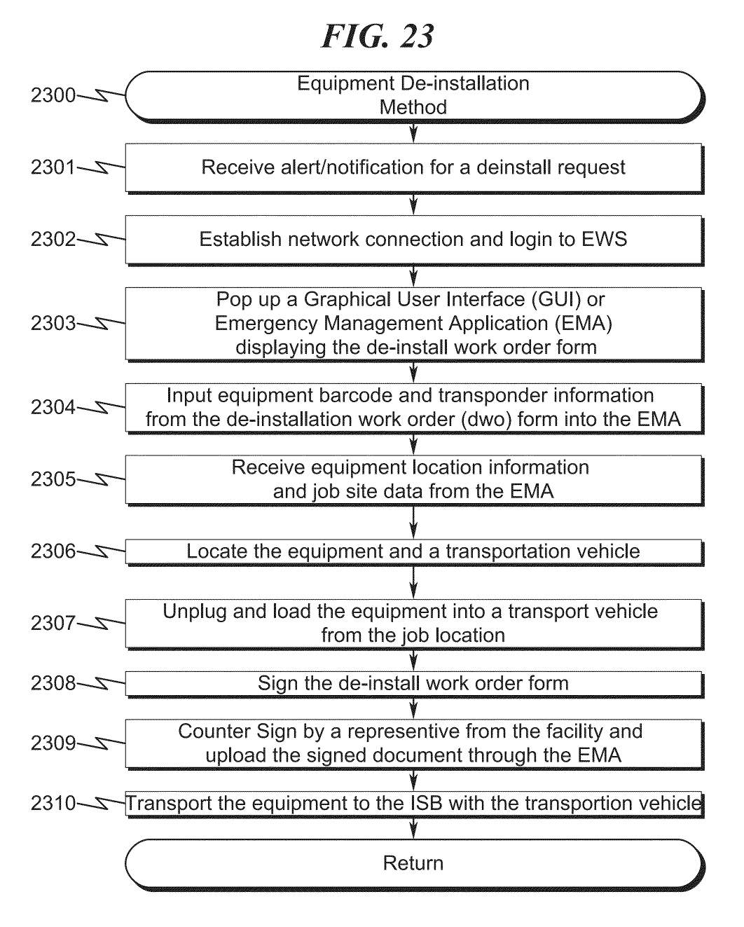

As generally seen in the flow chart of FIG. 3 (0300), the present invention method may be generally described in terms of the following steps:
(1) With the ECD, receiving a request from a customer agency for installing a power generator (0301);
(2) With the EWG, generating a work order from the received request as described in FIG. 10 (1000) (0302);
(3) Setting up an incident support base (ISB) with staging crew and the MCDs (0303);
(4) With the ERA and the EDB, locating the power generator and notifying crew members with the ETS as described in FIG. 14 (1400) (0304);
(5) Transporting the power generator to a job location (0305);
(6) Installing the power generator at the job location and updating completion status with the MCD as described in FIG. 18 (1800) (0306);
(7) Servicing the power generator on a scheduled basis and updating maintenance status with the MCD as described in FIG. 21 (2100) (0307);
(8) With the ECD, receiving a request from a customer agency for uninstalling the power generator as described in FIGS. 23 (2300) (0308); and
(9) Uninstalling the power generator and notifying stakeholders with the MCD (0309).

One skilled in the art will recognize that these method steps may be augmented or rearranged without limiting the teachings of the present invention. This general method summary may be augmented by the various elements described herein to produce a wide variety of invention embodiments consistent with this overall design description.

### Preferred Embodiment System Emergency Databases (0400-0800)

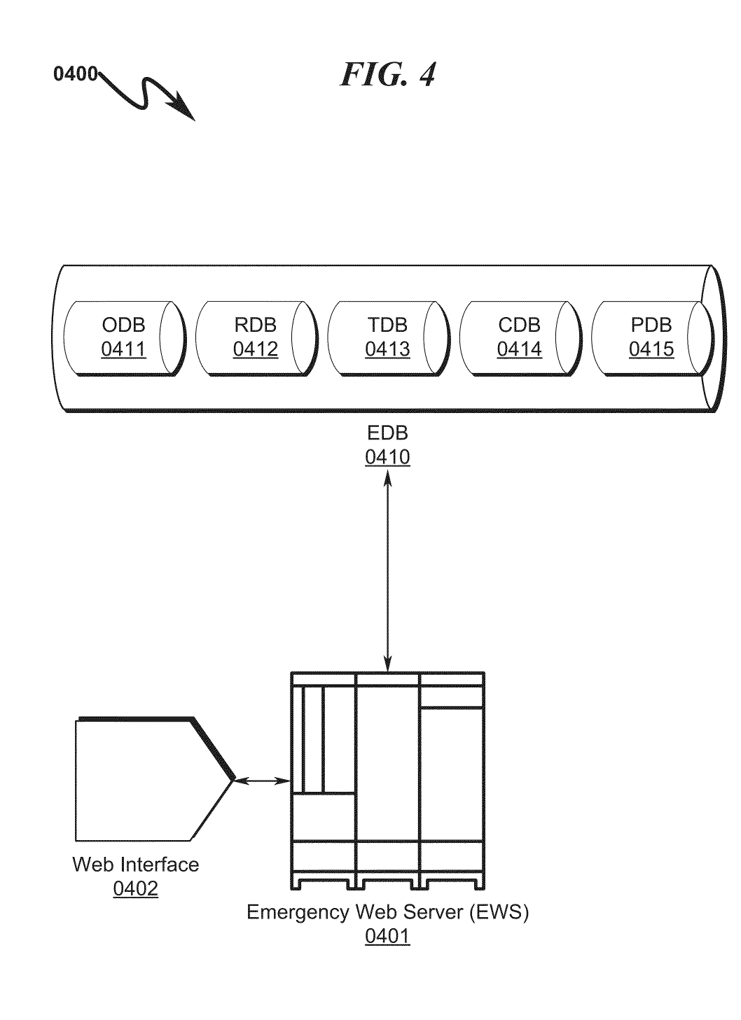

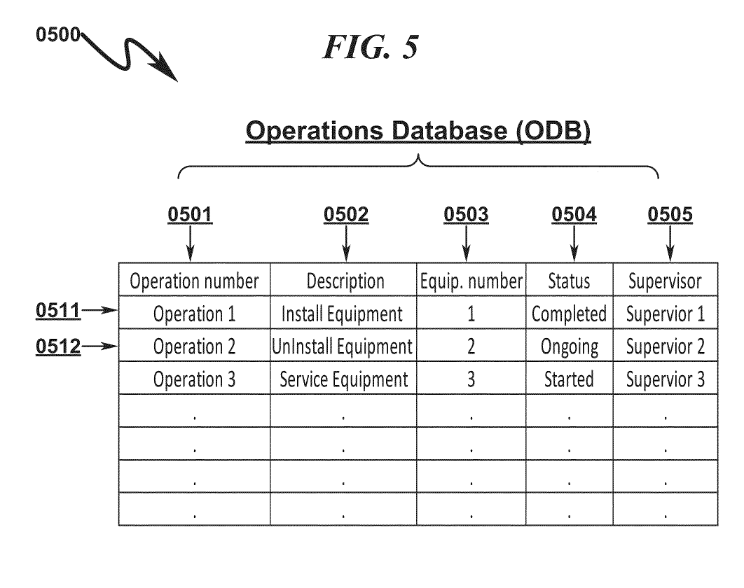

According to a preferred exemplary embodiment, emergency databases (EDB) (0410) may be seen in more detail as generally illustrated in FIG. 4 (0400). The EDBs (0410) may be maintained by a software program for modifying, storing and extracting information. It should be noted that, the implementation of the software program is beyond the scope of the present invention. A GUI or EMA is presented to a user allowing them to modify, store, and extract records. The EDB (0410) further comprises an operations database (ODB) (0411), a resources database (RDB) (0412), a transport database (TDB) (0413), a crew database (CDB) (0414), and a project database (PDB) (0415). According to a preferred exemplary embodiment, users may update or view records in the EDBs (0410) after establishing a connection with the EWS (0401) through a web interface (0402). The details of individual emergency databases are further described below in FIGS. 5, 6, 7, and 8.

FIG. 5 (0500) generally illustrates an operations database (ODB) (0411) that comprises plural records relating to operations numbers (0501), operations descriptions (0502), equipment numbers (0503), operation status (0504), and supervisor/incident commanders (0505). Users such as administrators or supervisors may have access to update records (0511, 0512) after establishing a connection with the EWS (0401).

For example, the record (0511) may comprise a power generator installation in an emergency operation, which may require 8 hours to complete. An administrator or a field crew member may update status field (0504) in the record as “started” (0511) before installing a power generator, as “ongoing” during installation of the power generator, or as “completed” after installing a power generator. In another preferred exemplary embodiment, the EWS (0401) may be programmed to automatically send real time alert messages to the stakeholders. The records may also be updated by administrators when there is a change in work order such as equipment changes.

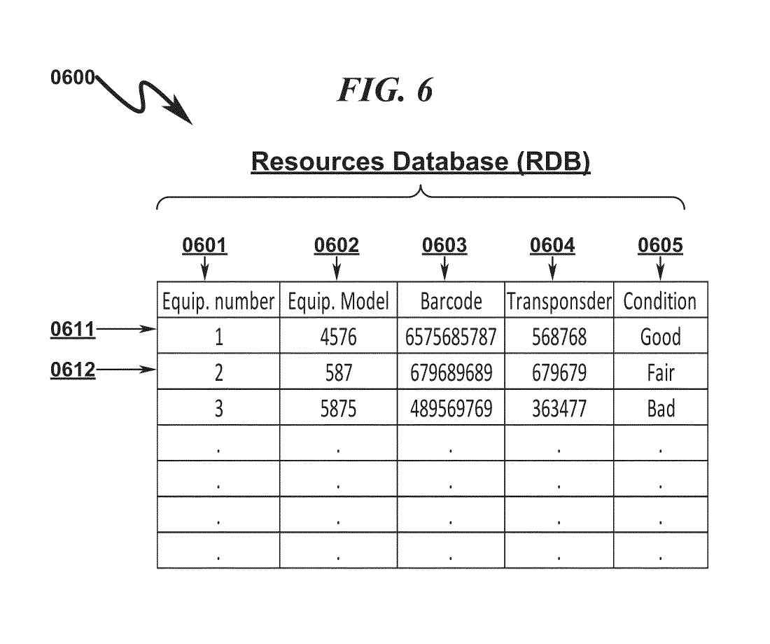

FIG. 6 (0600) generally illustrates a resources database (RDB) (0412) that comprises plural records related to equipment number (0601), equipment model (0602), equipment barcode (0603), transponder number (0604), and condition (0605) of the equipment. Users such as project administrators or supervisors may update records (0611, 0612) after establishing a connection with the EWS (0401) thorough a GUI in an emergency computing device or an emergency application on a MCD. The emergency resource analyzer (ERA) (0112) may analyze the records in the RDB (0412) to locate equipment and its condition. The equipment may then be prepared, transported, and installed at a job location. The power generator equipment may or may not be equipped with a transponder. The transponder may be used to communicate the functioning of the power generator in real time to the ISB through the EWS.

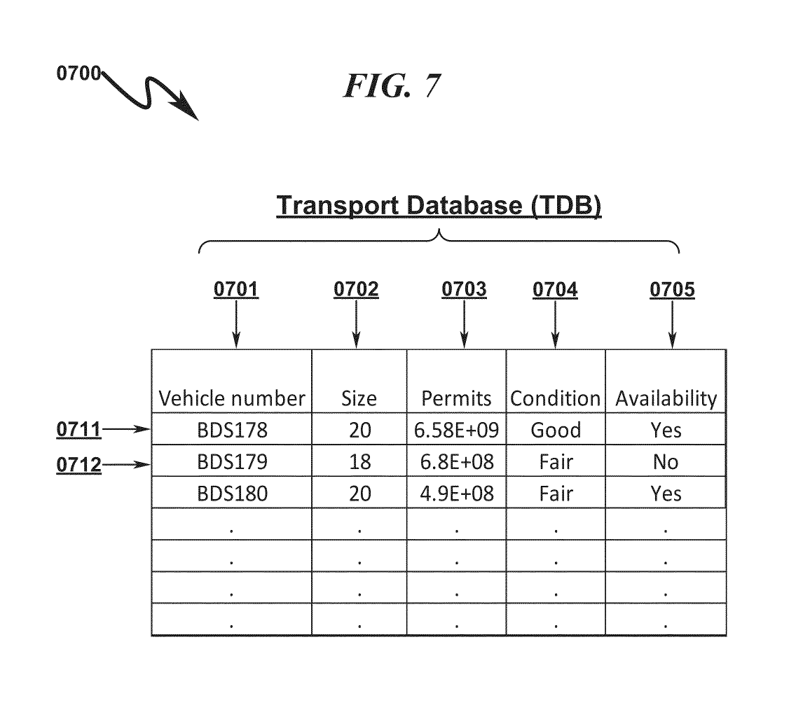

FIG. 7 (0700) generally illustrates a transport database (TDB) (0413) that comprises plural records relating to Vehicle number (0701), Size (0702), permits (0703), condition of the vehicle (0704), and availability (0705). Users such as project administrators or supervisors may update records (0711, 0712) after establishing a connection with the EWS (0401) thorough a GUI in an emergency computing device or an emergency application on a MCD.

The emergency resource analyzer (ERA) (0112) may analyze the records in the RDB (0412) to locate transportation equipment using a vehicle number and its availability. Some job locations may require heavier and larger power generators that in turn require larger vehicles to transport. The ERA analyzes the requirements accordingly. The ERA may also notify/alert to the MCD of a field crew driver with the location of the vehicle and the work order.

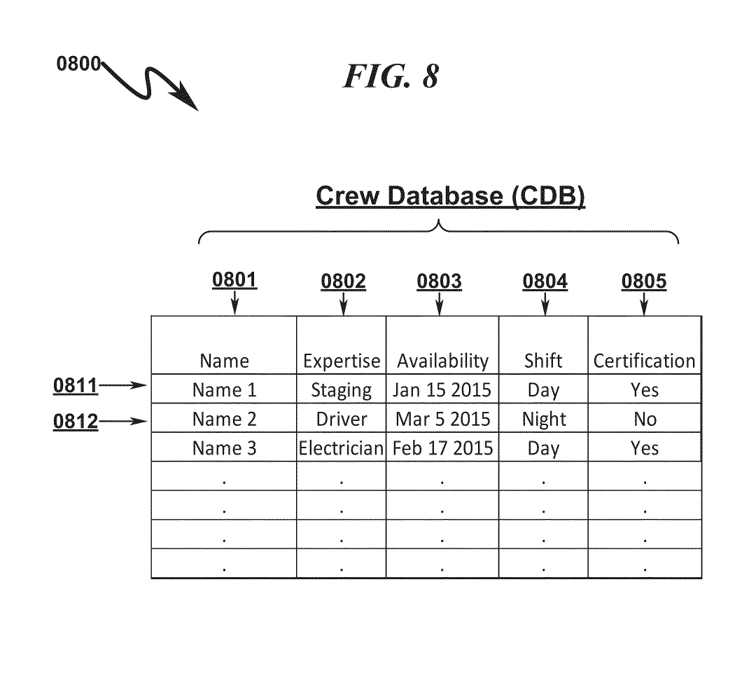

FIG. 8 (0800) generally illustrates a crew database (CDB) (0414) that comprises plural records relating to field crew (0801), expertise (0802), availability (0803), shift (0804), and certification. The ERA (0112) analyzes the resources and assigns the crew member to a job according to the operation requirements. For example, the operation may require a licensed electrician to de-install a power generator in service. The ERA would search the CDB (0414) for a licensed electrician. Similarly, the ERA may analyze the resources based on the availability and nature of the operation. For example, staging crew members coordinate the logistical operations at an ISB. Similarly, drivers are chosen based on the experience or certification.

A crew member, administrator or a supervisor may update the records (0811, 0812). For example, an electrician may update a record (0811). The electrician may update the record with availability, expertise, shift, and certification information. An electrician may also update record (0611) electronically or wirelessly after receiving work order information. In another preferred exemplary embodiment, the EWS (0401) may be programmed to automatically send alert messages to the electrician to update records in the CDB (0414). Additionally, the electrician may automatically change the availability when the scope of the operation or distance to the job location changes.

### Preferred Exemplary Emergency System Graphical User Interface (GUI) (0900-1000)

As generally seen in FIG. 9 (0900) and FIG. 10 (1000), a preferred exemplary graphical user interface is illustrated, wherein an application is displayed on an emergency computing device (ECD) or as an emergency management application (EMA) on a mobile computing device. Users such as administrators, staging crew members and field crew members may add, retrieve, delete or update information to the databases or other project related files. A supervisor or an administrator may set appropriate access controls to various users depending on the sensitivity of the information.

### Preferred Exemplary Create and Process Work Order Method Embodiment (1100)

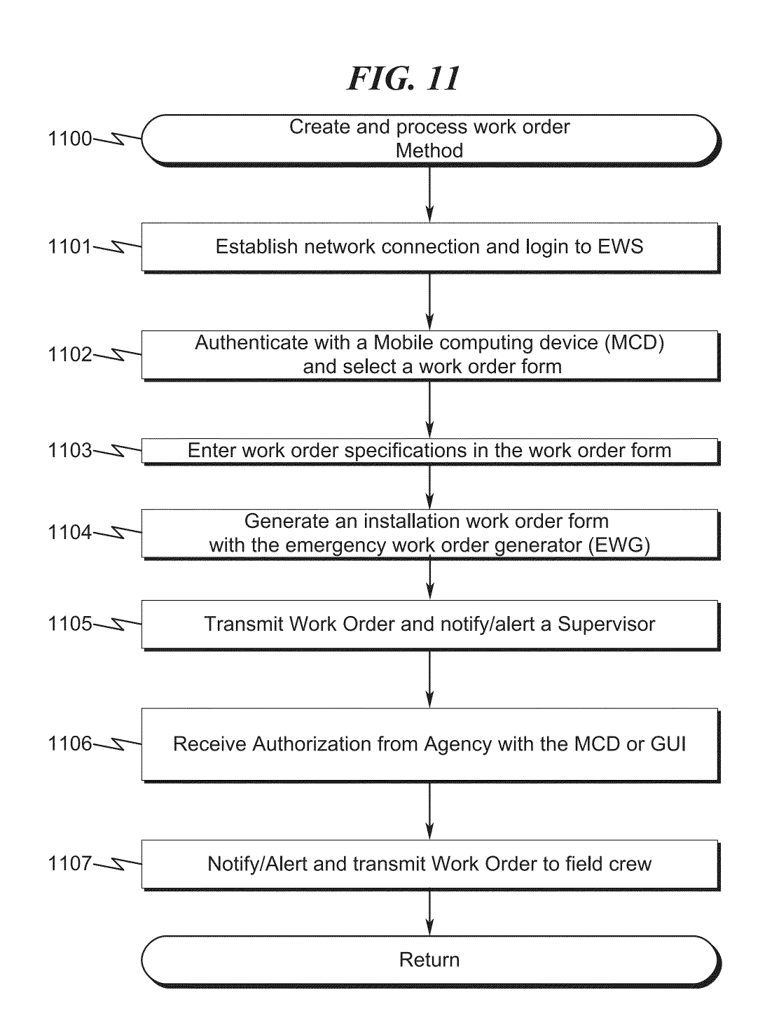

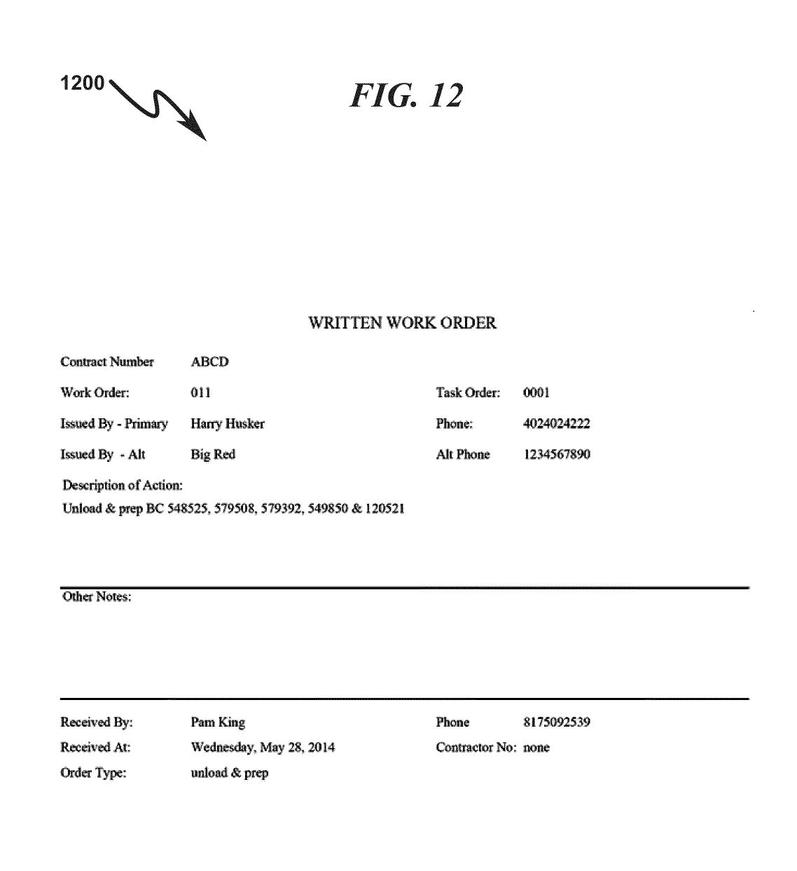

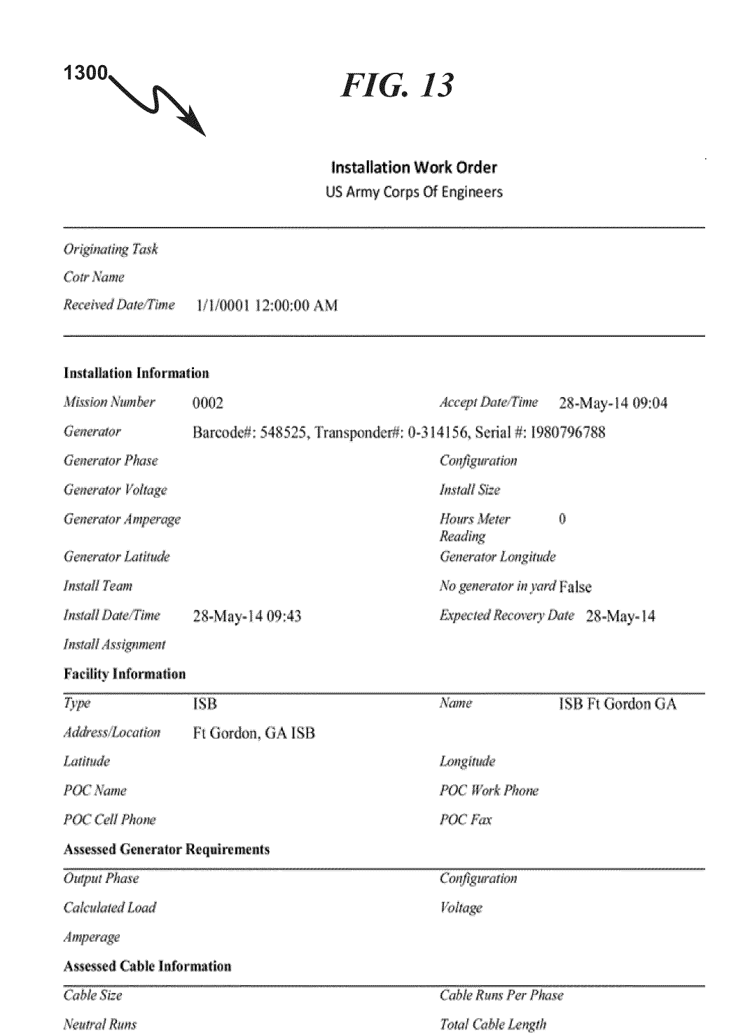

As generally seen in the flow chart of FIG. 11 (1100), a preferred exemplary create and process work order method may be generally described in terms of the following steps:
(1) With an emergency computing device (ECD) or an emergency management application (EMA), establishing a network connection and logging into an emergency web server (1101);
(2) Authenticating access to the EWS with the ECD or EMA and selecting a work order form (1102);
(3) With a GUI on the ECD, inputting work order specifications in the work order form as received in the written/electronic work order request as shown below in FIG. 12 (1200) (1103);
(4) With the emergency work order generator (EWG), generating an installation work order form (IWO) as illustrated in FIG. 13 (1300) and FIG. 14 (1400) (1104);
(5) With the MCD/EMA, transmitting the IWO and notifying a supervisor (1105);
(6) Receiving an authorization for the IWO from the customer agency with the MCD or GUI (1106);
(7) Notifying/alerting staging/field crew of the IWO with the MCD or GUI (1107); and
(8) Returning to emergency power management method step (0302).

### Preferred Exemplary Installation Work Order (1200-1400)

FIG. 12 (1200) shows a written work order received from a customer agency. The work order may be received electronically through the ECD or manually. The request may include installation, de-installation, repair, service, or re-fuel tasks. Detailed description of the written work order is entered into an installation work order form as shown in FIG. 13 (1300) and FIG. 14 (1400). An emergency work order generator (EWG) (0115) may be used to input the installation data such as job location, transponder number, generator number, generator model, barcode, phase, voltage, amperage, calculated load, output phase, cable size, and date of installation. The EWG may then generate the received information into an installation work order (IWO) which may then be transmitted to a supervisor/incident commander for authorization.

### Preferred Exemplary Equipment Preparation and Deployment Method Embodiment (1500)

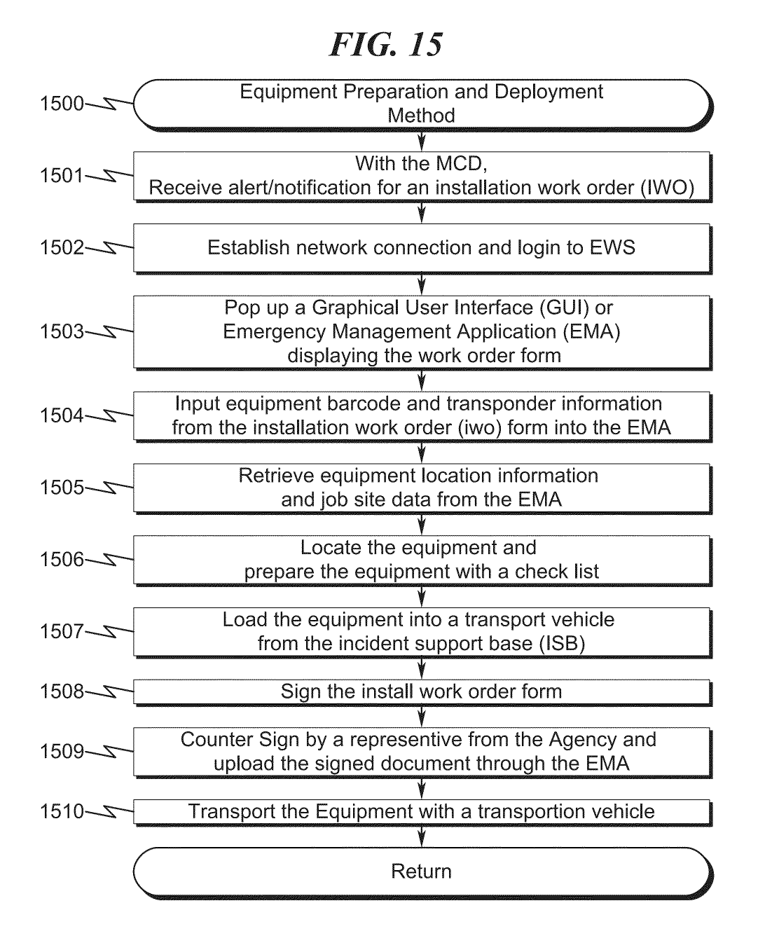

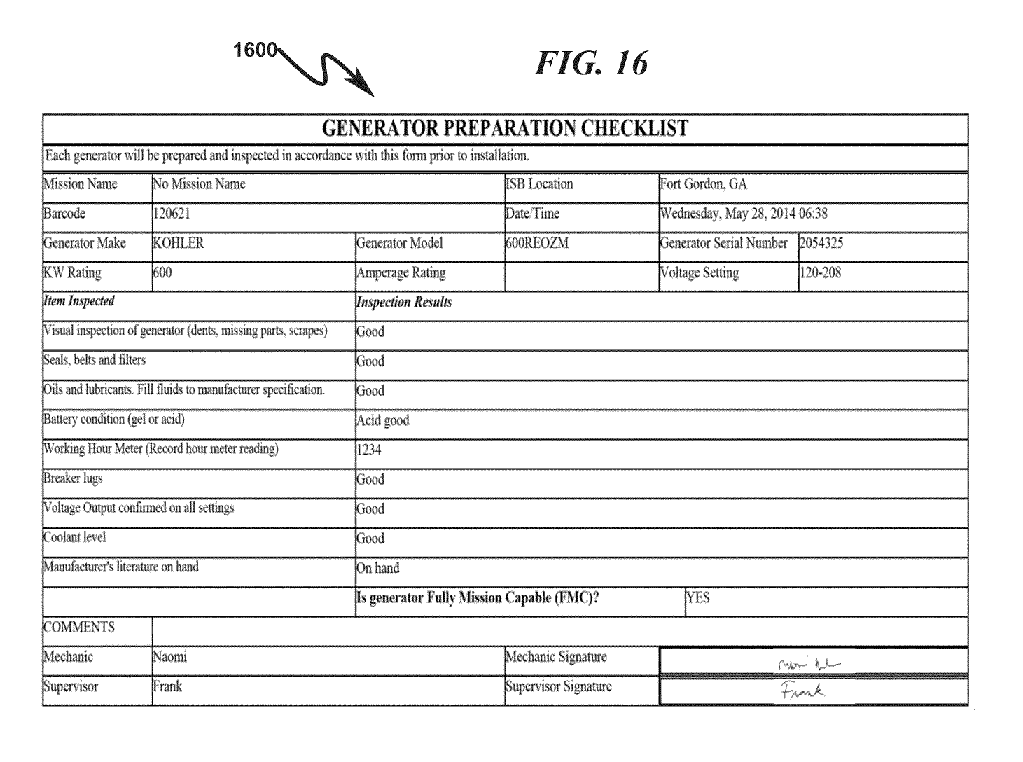

As generally seen in the flow chart of FIG. 15 (1500), a preferred exemplary equipment (power generator) preparation and deployment method may be generally described in terms of the following steps:
(1) With an mobile computing device (MCD), receiving a notification for an installation work order (IWO) (1501);
(2) With an emergency computing device (ECD) or an emergency management application (EMA), establishing a network connection and logging into an emergency web server (1502);
(3) Authenticating access to the EWS with the ECD or EMA and selecting the work order form (1503);
(4) Inputting generator barcode and transponder information from the IWO (1504);
(5) With the EMA/GUI, extracting generator location information and job site data (1505);
(6) Locating the generator at the ISB and preparing the generator with a check list as shown below in FIG. 16 (1600) (1506);
(7) Loading the generator into a transport vehicle assigned to the task from the IWO (1507);
(8) With the MCD/EMA, signing the IWO and notifying a supervisor (1508);
(9) Receiving an counter sign authorization for the IWO from the customer agency with the MCD or GUI and uploading the signed IWO to the EWS through a network (1509);
(10) Transporting the generator with the transportation vehicle to the job location (1510); and
(11) Returning to emergency power management method step (0304).

### Preferred Exemplary Equipment Installation Method Embodiment (1800)

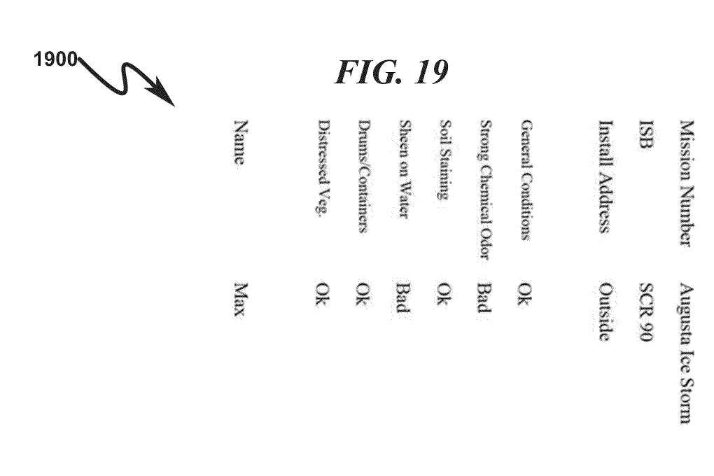

As generally seen in the flow chart of FIG. 18 (1800), a preferred exemplary power generator installation method may be generally described in terms of the following steps:
(1) Unloading the equipment from a transport vehicle after reaching a job location (facility) (1801);
(2) With an mobile computing device (MCD), documenting site specific conditions as shown in FIG. 19 (1900) (IWO) (1802);
(3) Planning cabling and generator connection to the facility (1803);
(4) With an electrician, running cables and connecting generator to the facility (1804);
(5) Completing generator hook up to the facility and authenticating with a counter sign by a facility manager (1805);
(6) Checking if a network connection is present, if not, proceeding to step (1808) (1806);
(7) Transmitting real time completion status to EWS with the MCD via the network (1807);
(8) Returning to incident support base (ISB) and transmitting real time completion status to EWS with the MCD via the network (1808);
(9) Returning to emergency power management method step (0306).

### Preferred Exemplary Equipment Service Method Embodiment (2100)

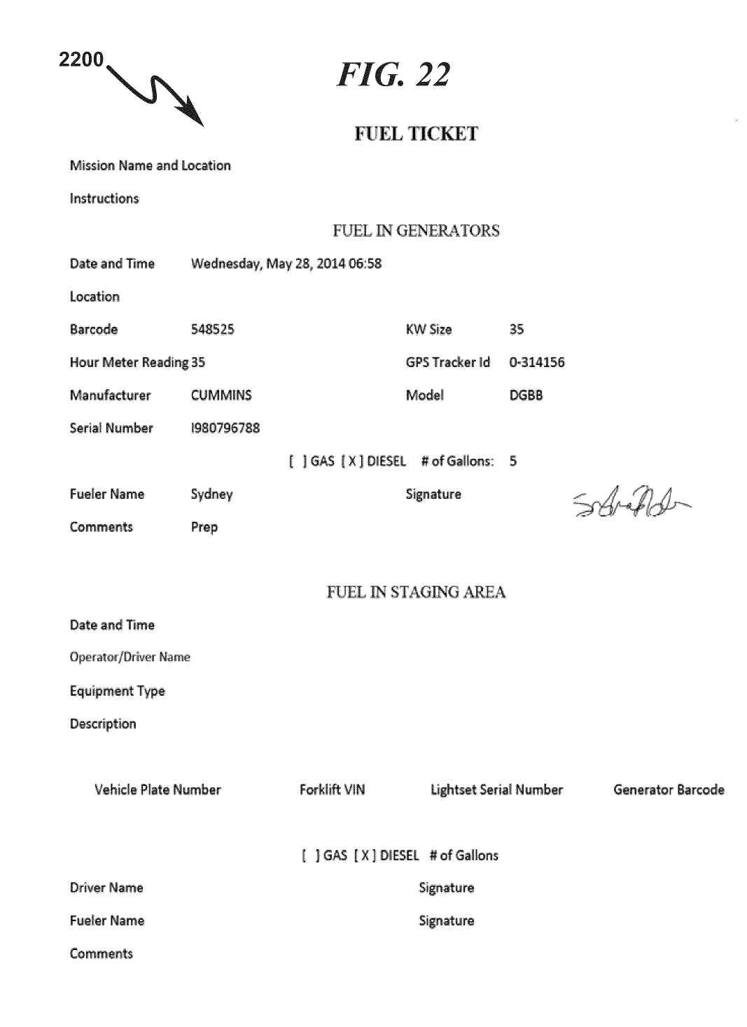

As generally seen in the flow chart of FIG. 21 (2100), a preferred exemplary power generator service method may be generally described in terms of the following steps:
(1) With an mobile computing device (MCD), popping up a GUI/EMA displaying a fuel ticket form as shown in FIG. 22 (2200) (2101);
(2) Generating a fuel/service ticket with the EMA (2102);
(3) Refueling/Servicing the generator (2103);
(4) With the MCD, authenticating with a counter sign by a manager at the facility (2104);
(5) Checking if a network connection is present, if not, proceeding to step (2107) (2105);
(6) Transmitting real time completion status to EWS with the MCD via the network (2106);
(7) Returning to incident support base (ISB) and transmitting real time completion status to EWS with the MCD via the network (2107);
(8) Returning to emergency power management method step (0307).

### Preferred Exemplary Equipment De-Installation Method Embodiment (2300)

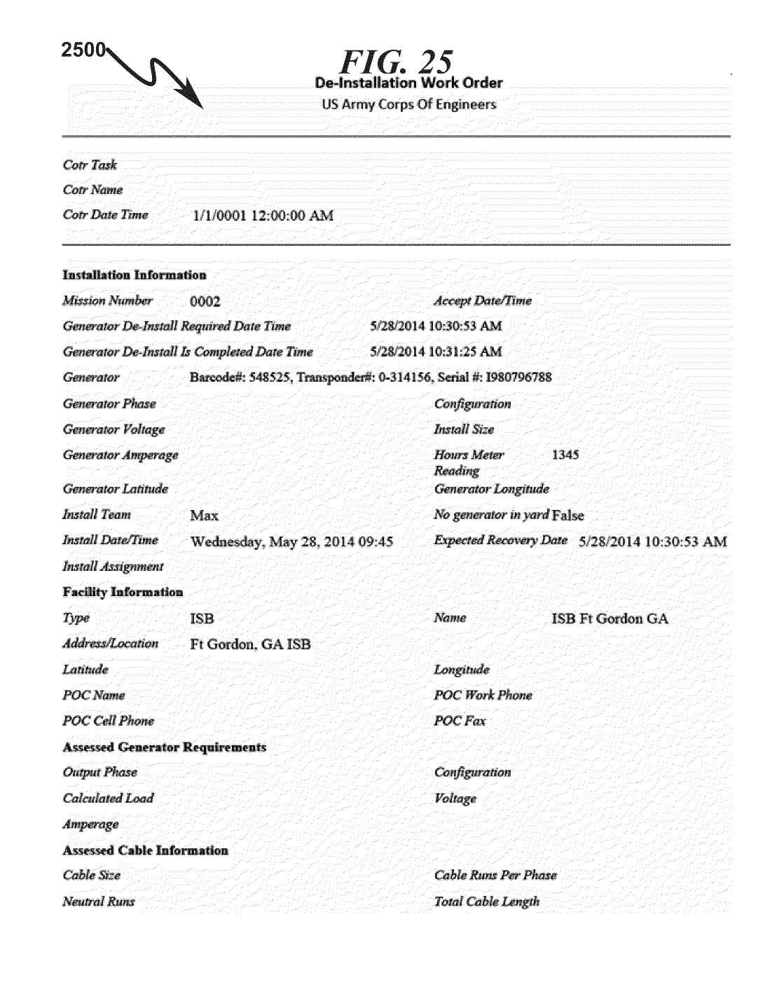

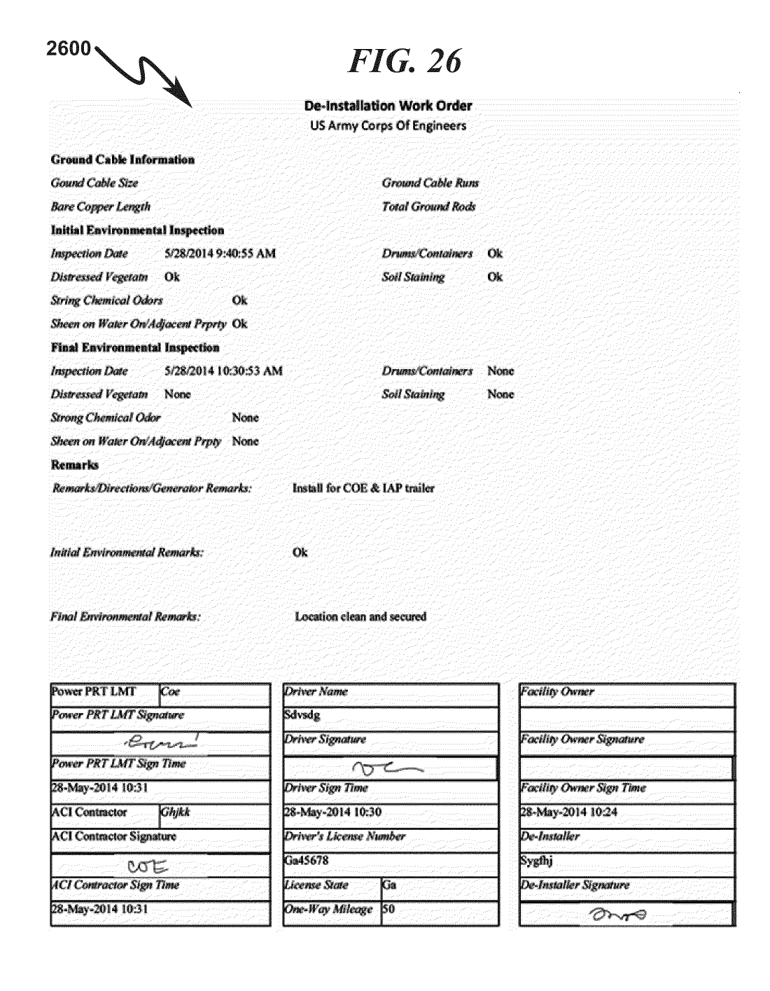

As generally seen in the flow chart of FIG. 23 (2300), a preferred exemplary power generator de-installation method may be generally described in terms of the following steps:
(1) With an mobile computing device (MCD), receiving a notification for an de-installation work order (IWO) (2301);
(2) With an emergency computing device (ECD) or an emergency management application (EMA), establishing a network connection and logging into an emergency web server (2302);
(3) Authenticating access to the EWS with the ECD or EMA and selecting the de-install work order (DWO) form as shown in FIG. 25 (2500) and FIG. 26 (2600) (2303);
(4) Inputting generator barcode and transponder information from the DWO (2304);
(5) With the EMA/GUI, extracting generator location information and job site data from the DWO (2305);
(6) Locating the generator at the job location and preparing the generator with a check list as shown below in FIG. 16 (1600) (2306);
(7) Unplugging and loading the generator into a transport vehicle assigned to the task from the DWO (2307);
(8) With the MCD/EMA, signing the DWO and notifying a supervisor (2308);
(9) Receiving an counter sign authorization for the DWO from the customer agency with the MCD or GUI and uploading the signed DWO to the EWS through a network (2309);
(10) Transporting the generator with the transportation vehicle to an incident support base (ISB) (2310); and
(11) Returning to emergency power management method step (0308).

### Preferred Exemplary Emergency Browser Interface (2700)

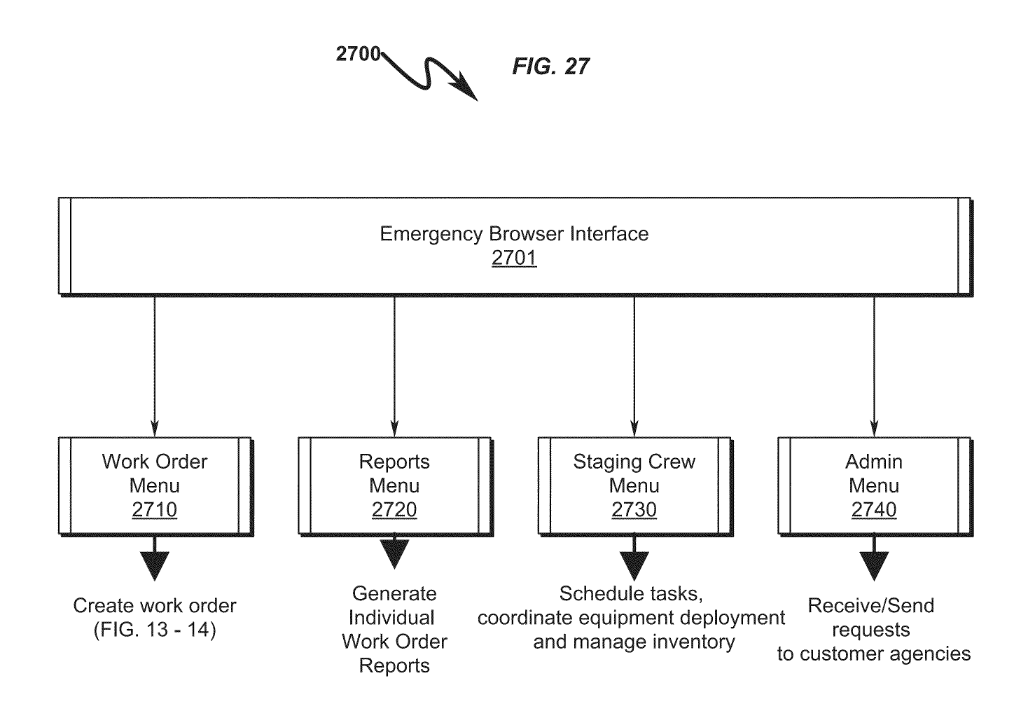

As generally seen in FIG. 27 (2700) an emergency browser interface is illustrated wherein the interface comprises menus for users. A work order menu (2710) may comprise a list of forms to generate work orders for installation, de-installation, service, repair or re-fuel. An emergency work order generator (EWG) transforms the inputted data into forms to respective work orders. The browser interface (2701) may also comprise a reports menu (2720) for generating customized reports such as individual operation execution reports, expenditure reports, personnel reports, generator availability reports, and/or job location specific reports. Furthermore, the interface (2701) may comprise a staging crew menu (2730) that schedules tasks, coordinate generator deployment and manage inventory at the incident support base. An administrator menu (2740) may comprise sending and receiving requests from customer agencies such as FEMA and Core of Engineers (COE). The interface (2701) provides a means to interact with the customers, servers and boot on the ground during emergency situations without the need for substantial human intervention.

### Preferred Exemplary Work Order Change Management Method Embodiment (2800)

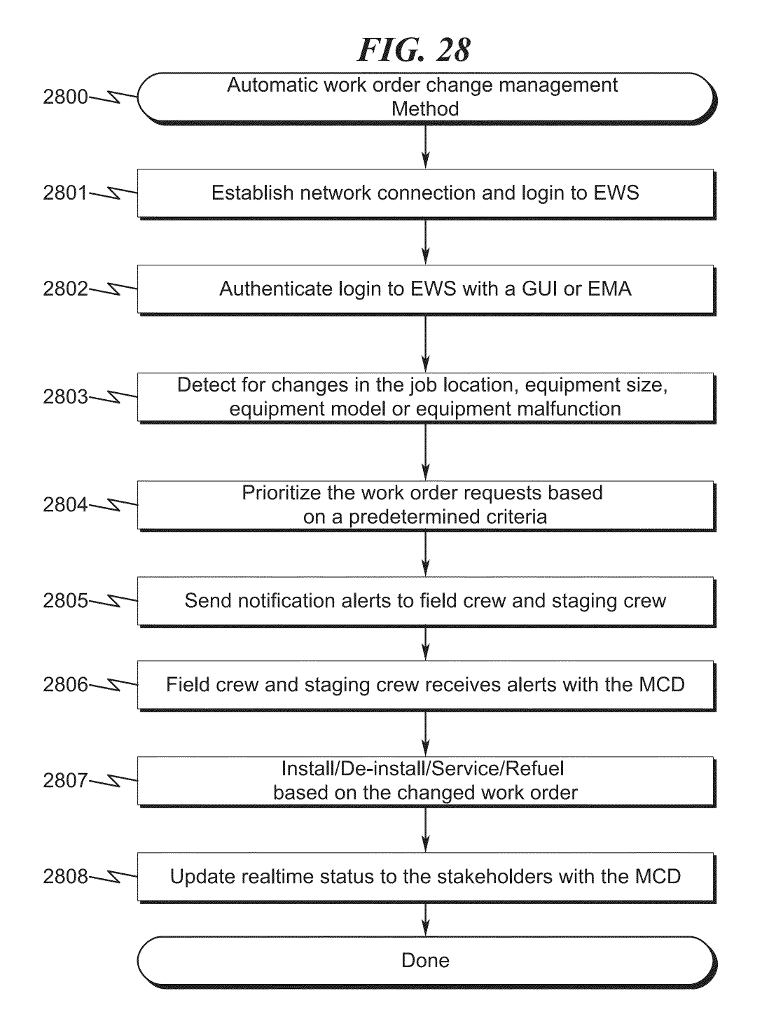

As generally seen in the flow chart of FIG. 28 (2800), a preferred exemplary work order change management method may be generally described in terms of the following steps:
(1) With an emergency computing device (ECD) or an emergency management application (EMA), establishing a network connection, and logging into an emergency web server (2801);
(2) Authenticating access to the EWS with the ECD or EMA and selecting a work order form (2802);
(3) With the emergency change management processor (EMP) in the EMA, detecting changes in ongoing operations for job location, generator size, generator model, and/or generator malfunction (2803);
(4) Prioritizing the work orders based on a pre-determined criteria (2804);
(5) With the ECD/EMA, notifying/alerting field crew and staging crew of the changes (2805);
(6) With the MCD/EMA, field crew and staging crew receiving change alerts (2806);
(7) Executing the changed work order for installation/de-installation/repair/re-fuel (2807); and
(8) Transmitting real time completion status to stakeholders with the MCD via the network (2808).

### Preferred Exemplary Power Generator Change Detection Method Embodiment (2900)

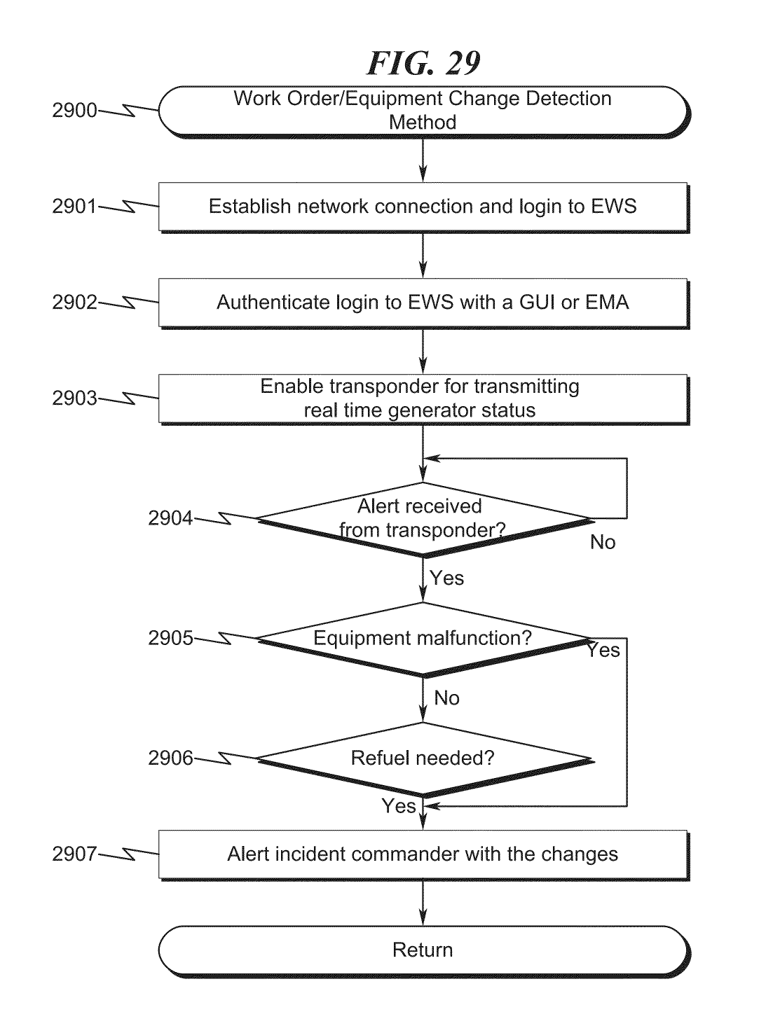

As generally seen in the flow chart of FIG. 29 (2900), a preferred exemplary power generator functionality change method may be generally described in terms of the following steps:
(1) With an emergency computing device (ECD) or an emergency management application (EMA), establishing a network connection, and logging into an emergency web server (2901);
(2) Authenticating access to the EWS with the ECD or EMA and selecting a work order form (2902);
(3) With the emergency change management processor (EMP) in the EMA, enable a transponder on a generator to transmit real time generator status (2903);
(4) With the EMP, determine if an alert is received from the transponder, if no, wait for an alert (2904);
(5) With the EMP, determine if the alert received is due to generator malfunction, if so, proceed to step (2907) (2905);
(6) With the EMP, determine if the alert received is due to fuel requirement (2906); and
(7) Alerting an incident commander with the changes in the equipment functioning (2907).

### Preferred Exemplary Power Generator with a Transponder System Embodiment (3000)

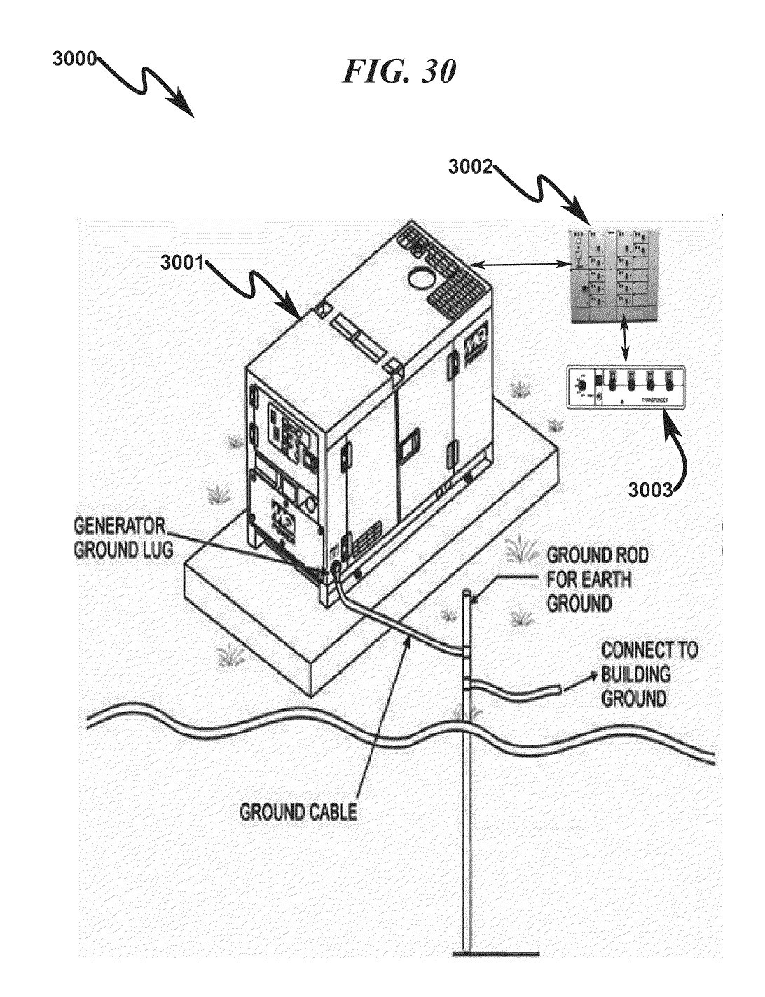

As generally shown in FIG. 30 (3000), a power generator (3001) is coupled to an electronic panel (3002) and a transponder (3003). According to a preferred exemplary embodiment, the functioning of a power generator is monitored in real time for malfunctions and fuel volume conditions. An electronic panel (3002) may be electrically coupled to the generator to monitor changes in load, voltage, fuel volume, and/or any other generator functionality. A threshold may be programmed in the electronic panel to alert and signal a transponder (3003) that is electronically coupled to the electronic panel (3002). The transponder in turn may transmit an alert signal to an emergency web server, with a code to indicate the failure mechanism such as load changes above a pre-determined threshold, output power, voltage fluctuations above a certain threshold and/or fuel volume. For example an alert may be transmitted when a fuel tank is nearing empty condition. Another example could be the generator is running at load conditions above its rated value. It is important that a power generator functions normally and service a facility during an emergency situation. It is equally important to detect and react to generator malfunction in real time to provide uninterrupted power service. For example, in a scenario where a hospital is serviced by a power generator during a disaster situation, the monitoring of the functioning of the power generator is of utmost importance. According to a preferred exemplary embodiment, the system detects power generator malfunctioning in real time and reacts to the condition during an emergency situation.

### System Summary

The present invention system anticipates a wide variety of variations in the basic theme of emergency, but can be generalized as an emergency management system comprising:
(a) emergency web server (EWS);
(b) emergency computing devices (ECDs);
(c) emergency databases (EDBs);
(d) emergency resource analyzer (ERA);
(e) emergency task scheduler (ETS);
(f) emergency work order generator (EWG);
(g) emergency change management processor (EMP); and
(h) emergency management application (EMA);

wherein
the EWS is configured to communicate with the EDBs, the EOS, the ERA, the ETS, the EWG, the EMP, and the EMA;
the EWS is configured to connect to a network to provide connectivity to the ECDs and a plurality of mobile computing devices (MCDs);
the ECDs are configured to enable a plurality of users to interact with the EWS and the EDBs;
the EDBs are configured to enable the users to update or extract records from the EDBs after establishing a connection with the EWS through the network;
the EWG is configured to generate a work order from a received customer agency request;
the EWG is configured to monitor the work order for updates and reports;
the ERA is configured to identify resources for the work orders and notify the resources of the work orders requirements;
the ETS is configured to dispatch work orders to crew members;
the EMP is configured to monitor changes in the work orders and alert the crew members of the changes; and
the EMA is configured to be launched on the ECDs and mobile computing devices (MCDs) to permit users to input, retrieve and report operations related data.

This general system summary may be augmented by the various elements described herein to produce a wide variety of invention embodiments consistent with this overall design description.

### Method Summary

The present invention method anticipates a wide variety of variations in the basic theme of implementation, but can be generalized as an emergency management method wherein the method is performed on an emergency management system comprising:
(a) emergency web server (EWS);
(b) emergency computing devices (ECDs);
(c) emergency databases (EDBs);
(d) emergency resource analyzer (ERA);
(e) emergency task scheduler (ETS);
(f) emergency work order generator (EWG);
(g) emergency change management processor (EMP); and
(h) emergency management application (EMA);

wherein
the EWS is configured to communicate with the EDBs, the EOS, the ERA, the ETS, the EWG, the EMP, and the EMA;
the EWS is configured to connect to a network to provide connectivity to the ECDs and a plurality of mobile computing devices (MCDs);
the ECDs are configured to enable a plurality of users to interact with the EWS and the EDBs;
the EDBs are configured to enable the users to update or extract records from the EDBs after establishing a connection with the EWS through the network;
the ERA is configured to identify resources for the operations and notify the resources of the operation requirements;
the ETS is configured to dispatch work orders to crew members;
the EWG is configured to generate a work order from a received customer agency request;
the EWG is configured to monitor the work order for updates and reports;
the EMP is configured to monitor changes in the work orders and alert the crew members of the changes; and
the EMA is configured to be launched on the ECDs and mobile computing devices (MCDs) to permit users to input, retrieve and report operations related data;

wherein the method comprises the steps of:
(1) with the ECD, receiving a request from a customer agency for installing a power generator;
(2) with the EWG, generating a work order from the received request;
(3) setting up an incident support base (ISB) with staging crew and the MCDs;
(4) with the ERA, locating the power generator with the EDB and notifying crew members with the ETS;
(5) transporting the power generator to a job location;
(6) installing the power generator at the job location and updating completion status with the MCD;
(7) servicing the power generator on a scheduled basis and updating maintenance status with the MCD;
(8) with the ECD, receiving a request from a customer agency for uninstalling the power generator; and
(9) uninstalling the power generator and notifying stakeholders with the MCD.

This general method summary may be augmented by the various elements described herein to produce a wide variety of invention embodiments consistent with this overall design description.

### System/Method Variations

The present invention anticipates a wide variety of variations in the basic theme of emergency. The examples presented previously do not represent the entire scope of possible usages. They are meant to cite a few of the almost limitless possibilities.

This basic system and method may be augmented with a variety of ancillary embodiments, including but not limited to:
An embodiment wherein said ECDs further comprises a local database (LDB), a graphical user interface (GUI) with a pointing device and a microprocessor that computes instructions read from a computer readable media.
An embodiment wherein said users interface with a web browser selectable by said pointing device to update said records in said EDBs.
An embodiment wherein said EDBs further comprises an operations database (ODB), a resources database (RDB), an equipment database (EDB), a transport database (TDB), and a project database (PDB).
An embodiment wherein said ERA further prioritizes work orders based on predetermined criteria.
An embodiment wherein said EMP is further configured to be in real time communication with a transponder coupled to a power generator.
An embodiment wherein said EMP is further configured to detect changes in said power generator functioning.
An embodiment wherein said EMA is further configured to provide real time updates to said stakeholders.
An embodiment wherein said EMP detects changes in work orders and reacts dynamically to alert said stakeholders.
An embodiment wherein said MCD is selected from a group consisting of: a tablet computer, a cellular phone, and a smartphone.

One skilled in the art will recognize that other embodiments are possible based on combinations of elements taught within the above invention description.

### CONCLUSION

An automated disaster management system and method for power generators has been disclosed. The system/method includes emergency computing devices (ECDs) communicating with an emergency web server (EWS) over a network. The EWS interacts with an emergency database (EDB), emergency task scheduler (ETS), emergency resource analyzer (ERA), emergency work order generator (EWG), and emergency management application (EMA). A service agency receives a request for installation/service/de-installation from a customer agency through the EMA. The EWG generates and transmits a work order to a crew that receives the work order and performs the operation at the job site after locating it with the ERA. Before, during, and after completion of an operation, the crew member via the EMA/EWS, dynamically updates reports to government and local stakeholders. Another embodiment includes a system to detect generator malfunctioning in real time and react accordingly to provide uninterrupted service during an emergency situation.

1. An emergency response management system comprising:
(a) emergency web server (EWS);
(b) emergency computing devices (ECDs);
(c) emergency databases (EDBs);
(d) emergency resource analyzer (ERA);
(e) emergency task scheduler (ETS);
(f) emergency work order generator (EWG);
(g) emergency change management processor (EMP); and
(h) emergency management application (EMA);
wherein
said EWS is configured to communicate with said EDBs, said EOS, said ERA, said ETS, said EWG, said EMP, and said EMA;
said EWS is configured to connect to a network to provide connectivity to said ECDs and a plurality of mobile computing devices (MCDs);
said ECDs are configured to enable a plurality of users to interact with said EWS and said EDBs;
said EDBs are configured to enable said users to update or extract records from said EDBs after establishing a connection with said EWS through said network;
said EWG is configured to generate a work order from a received customer agency request;
said EWG is configured to monitor said work order for updates and reports;
said ERA is configured to identify resources for said work orders and notify said resources of said work orders requirements;
said ETS is configured to dispatch work orders to crew members;
said EMP is configured to monitor changes in said work orders and alert said crew members of said changes;
said EMP is further configured to be in real time communication with a transponder;
said transponder is integrated with a power generator; and
said EMA is configured to be launched on said ECDs and mobile computing devices (MCDs) to permit users to input, retrieve and report operations related data.

2. The emergency management system of claim 1 wherein said ECDs further comprises a local database (LDB), a graphical user interface (GUI) with a pointing device and a microprocessor that computes instructions read from a computer readable media.

3. The emergency management system of claim 2 wherein said users interface with a web browser selectable by said pointing device to update said records in said EDBs.

4. The emergency management system of claim 1 wherein said EDBs further comprises an operations database (ODB), a resources database (RDB), an equipment database (EDB), a transport database (TDB), and a project database (PDB).

5. The emergency management system of claim 1 wherein said ERA further prioritizes work orders based on pre-determined criteria.

6. (canceled)

7. The emergency management system of claim 1 wherein said EMP is further configured to detect changes in said power generator functioning.

8. The emergency management system of claim 1 wherein said EMA is further configured to provide real time updates to said stakeholders.

9. The emergency management system of claim 1 wherein said EMP detects changes in work orders and reacts dynamically to alert said stakeholders.

10. The emergency management system of claim 1 wherein said MCD is selected from a group consisting of: a tablet computer, a cellular phone, and a smartphone.

11. An emergency response management method, said method utilizing an emergency management system, said system comprising:
(a) emergency web server (EWS);
(b) emergency computing devices (ECDs);
(c) emergency databases (EDBs);
(d) emergency resource analyzer (ERA);
(e) emergency task scheduler (ETS);
(f) emergency work order generator (EWG);
(g) emergency change management processor (EMP); and
(h) emergency management application (EMA);
wherein
said EWS is configured to communicate with said EDBs, said EOS, said ERA, said ETS, said EWG, said EMP, and said EMA;
said EWS is configured to connect to a network to provide connectivity to said ECDs and a plurality of mobile computing devices (MCDs);
said ECDs are configured to enable a plurality of users to interact with said EWS and said EDBs;
said EDBs are configured to enable said users to update or extract records from said EDBs after establishing a connection with said EWS through said network;
said EWG is configured to generate a work order from a received customer agency request;
said EWG is configured to monitor said work order for updates and reports;
said ERA is configured to identify resources for said work orders and notify said resources of said work orders requirements;
said ETS is configured to dispatch work orders to crew members;
said EMP is configured to monitor changes in said work orders and alert said crew members of said changes; and
said EMP is further configured to be in real time communication with a transponder said transponder is integrated with a power generator; and
said EMA is configured to be launched on said ECDs and mobile computing devices (MCDs) to permit users to input, retrieve and report operations related data;
wherein said method comprises the steps of:
(1) with said ECD, receiving a request from a customer agency for installing said power generator;
(2) with said EWG, generating a work order from said received request;
(3) setting up an incident support base (ISB) with staging crew and said MCDs;
(4) with said ERA, locating said power generator with said EDB and notifying crew members with said ETS;
(5) transporting said power generator to a job location;
(6) installing said power generator at said job location and updating completion status with said MCD;
(7) servicing said power generator on a scheduled basis and updating maintenance status with said MCD;
(8) with said ECD, receiving a request from a customer agency for uninstalling said power generator; and
(9) uninstalling said power generator and notifying stakeholders with said MCD.

12. The emergency response management method of claim 11 wherein said ECDs further comprises a local database (LDB), a graphical user interface (GUI) with a pointing device and a microprocessor that computes instructions read from a computer readable media.

13. The emergency response management method of claim 12 wherein said users interface with a web browser selectable by said pointing device to update said records in said EDBs.

14. The emergency response management method of claim 11 wherein said EDBs further comprises an operations database (ODB), a resources database (RDB), an equipment database (EDB), a transport database (TDB), and a project database (PDB).

15. The emergency response management method of claim 11 wherein said ERA further prioritizes work orders based on predetermined criteria.

16. (canceled)

17. The emergency response management method of claim 11 wherein said EMP is further configured to detect changes in said power generator functioning.

18. The emergency response management method of claim 11 wherein said EMA is further configured to provide real time updates to said stakeholders.

19. The emergency response management method of claim 11 wherein said EMP detects changes in work orders and reacts dynamically to alert said stakeholders.

20. The emergency response management method of claim 11 wherein said MCD is selected from a group consisting of: a tablet computer, a cellular phone, and a smartphone.

21. A real time power generator change detection method installed in an emergency response system, said method comprising the steps of:
(1) enabling a transponder for transmitting real time power generator status;
(2) if an alert is detected, transmitting said alert to an emergency response server in said emergency response system;
(3) determining if said alert is related to said power generator malfunction, if not, proceeding to step (5);
(4) determining if said alert is related to fueling said power generator malfunction; and
(5) alerting an incident commander in said emergency response system through said emergency response server.

22. The real time power generator change detection method of claim 21 wherein said alert is configured with a code to indicate said failure mechanism.
